(19) United States
(12) Patent Application Publication
(10) Pub. No.: US 2024/0173736 A1
(43) Pub. Date: May 30, 2024

(54) METHODS, SYSTEMS, AND COMPUTER PROGRAM PRODUCTS FOR REMOTELY OPERATING A DEVICE IN REAL TIME OR NEAR REAL TIME

(71) Applicant: Paint By Motors, LLC., Gainesville, FL (US)

(72) Inventor: Jake A. Hyvonen, Gainesville, FL (US)

(21) Appl. No.: 18/481,329

(22) Filed: Oct. 5, 2023

Related U.S. Application Data
(60) Provisional application No. 63/385,077, filed on Nov. 28, 2022.

(51) Int. Cl. B05B 13/04; G05B 19/418

(52) U.S. Cl. CPC B05B 13/0431; G05B 19/4181; G05B 2219/45013; G05B 2219/45065

(57) ABSTRACT

The subject matter described herein includes methods, systems, and computer program products for remotely operating a painting device in real time or near real time using a digital user interface to produce a physical artwork According to one method, input is received from a user via a user interface and automatically translated into instructions that, when executed by a remotely located painting device, cause the operation of the painting device to be controlled by the user in real time or near real time. Operation of the movement and position of the painting device in real time or near real time based on the received instructions to eject paint from one or more nozzles onto a physical surface.

### CROSS-REFERENCE TO RELATED APPLICATIONS

This application claims the benefit of priority of U.S. provisional patent application No. 63/385,077, entitled “METHODS, SYSTEMS, AND COMPUTER PROGRAM PRODUCTS FOR REMOTELY OPERATING A DEVICE IN REAL TIME OR NEAR REAL TIME”, filed on Nov. 28, 2022, which is incorporated by reference herein in its entirety.

### BACKGROUND

### Field of the Invention

The present invention relates to painting artwork on a canvas or similar surface, and more specifically, to methods, systems, and computer program products for remotely operating a device in real time or near real time using a digital user interface to produce a physical artwork.

### Description of Related Art

Art, artwork, or other aesthetic applications of paint to a surface (i.e., applying a pigmented liquid, liquefiable, or solid mastic composition that, after application to a substrate in a thin layer, converts to a solid film, in order to protect, color, or provide texture) have traditionally been performed manually by an artist.

Various tools have been used for applying paint to a surface, such as a canvas, including brushes, airbrushes, spray cans, meshes and squeegees for screen printing, dipping tanks, heat devices for thermosetting, electrical devices for electrostatic powder coating, and many more.

Traditional painting methods and tools have several drawbacks and, as a result, automated painting methods have been introduced. These include, for example, printing a digital image on a canvas using machines that provide increased scale and affordability over traditional methods.

Conventional computerized or computer-assisted methods, however, do not allow for artists to remotely produce a physical painting in real time, or near real time, using a digital interface. Instead, such methods often only allow artists to submit a fully completed digital artwork and at some later time (e.g., weeks) receive a physical copy of their artwork.

Accordingly, a need exists for improved methods and systems for painting a physical artwork on a surface, such as a canvas, that can be performed remotely, digitally, and in real time or near real time.

### BRIEF SUMMARY

The subject matter described herein includes methods, systems, and computer program products for remotely operating a material application device, such as a painting device, in real time or near real time using a digital user interface to produce a physical artwork. According to one method, input is received from a user via a user interface and automatically translated into instructions that, when executed by a remotely located painting device, cause the operation of the painting device to be controlled by the user in real time or near real time. Operation of the movement and position of the painting device in real time or near real time based on the received instructions to eject paint from one or more nozzles onto a physical surface.

According to one system, the system includes a user interface for receiving input from a user. A translation module automatically translates the user input into instructions that, when executed by a remotely located painting device, cause the operation of the painting device to be controlled by the user in real time or near real time. A painting device ejects paint from one or more nozzles onto a physical surface for in real time or near real time based on the received instructions.

According to one apparatus, the painting apparatus includes one or more painting devices including at least one of a plurality of syringes, each syringe containing a paint and having a plunger. The painting apparatus further includes a communications module for receiving at least one of input from a user or instructions from a translation module, wherein the user input is automatically translated into the instructions such that, when executed by the painting device, they cause the operation of the painting device to be controlled by the user in real time or near real time. The painting apparatus further includes a control module for operating the movement and position of the painting device in real time or near real time based on the received instructions to eject paint from one or more nozzles onto a physical surface, wherein the control module is configured to communicate with one or more micro controller units for controlling the movement and position of the painting devices and to communicate with one or more stepper motors for controlling the plungers associated with each of the syringes for ejecting the paint therefrom.

### BRIEF DESCRIPTION OF THE SEVERAL VIEWS OF THE DRAWINGS

FIG. 1A is a system diagram illustrating components for remotely operating a painting device using a digital interface according to an embodiment of the subject matter described herein.

FIG. 1B is a perspective view illustrating an exemplary painting device according to an embodiment of the subject matter described herein.

FIG. 2 is a flow diagram illustrating remote operation of a painting device using a digital interface according to an embodiment of the subject matter described herein.

FIG. 3A is a diagram illustrating an exemplary painting device before paint is applied to the substrate according to an embodiment of the subject matter described herein.

FIG. 3B is a diagram illustrating the exemplary painting device of FIG. 3A after paint is applied to the substrate according to an embodiment of the subject matter described herein.

FIG. 3C is a diagram illustrating the exemplary painting device of FIG. 3B where the substrate is tilted one or more axes according to an embodiment of the subject matter described herein.

FIG. 3D is a diagram illustrating an exemplary user interface for remotely operating a painting device according to an embodiment of the subject matter described herein.

FIG. 4 is a diagram illustrating an exemplary digital image captured of a physical artwork produced by remotely operating a painting device using a digital interface according to an embodiment of the subject matter described herein.

FIG. 5A is a diagram illustrating a perspective view of grip-release-actuator sub-assembly of the painting device according to an embodiment of the subject matter described herein.

FIG. 5B is a diagram illustrating a perspective view of grip-release-actuator sub-assembly of the painting device according to an embodiment of the subject matter described herein.

FIG. 5C is a diagram illustrating a perspective view of grip-release-actuator sub-assembly of the painting device according to an embodiment of the subject matter described herein.

FIG. 5D is a diagram illustrating a perspective view of grip-release-actuator sub-assembly of the painting device according to an embodiment of the subject matter described herein.

FIG. 5E is a diagram illustrating a perspective view of grip-release-actuator sub-assembly of the painting device according to an embodiment of the subject matter described herein.

FIG. 6A is a diagram illustrating a perspective view of a syringe assembly of the painting device according to an embodiment of the subject matter described herein.

FIG. 6B is a diagram illustrating an opposite perspective view of the syringe assembly of FIG. 6A according to an embodiment of the subject matter described herein.

FIG. 6C is a diagram illustrating a perspective view of a syringe holding rack of the painting device according to an embodiment of the subject matter described herein.

FIG. 6D is a diagram illustrating a perspective view of a syringe assembly of the painting device in an open position according to an embodiment of the subject matter described herein.

FIG. 6E is a diagram illustrating a perspective view of a syringe assembly of the painting device in a close position according to an embodiment of the subject matter described herein.

FIG. 6F is a diagram illustrating a close-up perspective view of a syringe assembly of the painting device according to an embodiment of the subject matter described herein.

FIG. 7 is a diagram illustrating various components of the painting device according to an embodiment of the subject matter described herein.

FIG. 8 is a perspective diagram illustrating a carousel for the painting device according to an embodiment of the subject matter described herein.

FIG. 9 is a system diagram illustrating components for remotely operating a painting device using a digital interface according to an embodiment of the subject matter described herein.

FIG. 10 is a system diagram illustrating example communications between components for remotely operating a painting device using a digital interface according to an embodiment of the subject matter described herein.

FIG. 11 is a message sequence diagram corresponding to the system diagram of FIG. 11 illustrating example communications between components for remotely operating a painting device using a digital interface according to an embodiment of the subject matter described herein.

### DETAILED DESCRIPTION

The subject matter described herein includes for methods and systems for remotely operating a painting device in real time or near real time using a digital user interface to produce a physical artwork According to one method, input is received from a user via a user interface and automatically translated into instructions that, when executed by a remotely located painting device, cause the operation of the painting device to be controlled by the user in real time or near real time. Operation of the movement and position of the painting device in real time or near real time based on the received instructions to eject paint from one or more nozzles onto a physical surface. In other embodiments disclosed herein, the one or more nozzles may be one or more syringes each having a tip for dispensing paint contained in the syringe body. The one or more syringes may be stored, for example, in a rack and held in place using magnets or in a carousel and held in place by gravity. In contrast to conventional configurations, which create a physical copy of an existing digital artwork in non-real time, the present disclosure allows a remotely located artist to use a digital user interface to control the operation of a painting device to create artwork in real time or near real time.

The rack for holding one or more syringes using magnets may be referred to as a Grip-Release-Actuate assembly. This contrasts with a rotary carousel design by placing stationary mounts in a line for mounting the syringes. Additionally, a pair of threaded rods are attached to the plunger end of each syringe/syringe assembly. The threaded rods on the syringe engage with a long primary threaded rod located in the painting device. Magnets located on the syringe assembly are aligned with corresponding magnets or ferromagnetic material on the painting device such that, when a syringe is loaded into the painting device, the threads of the primary rod are interleaved with the threads of the pair of rods on the syringe. By rotating the primary threaded rod, and holding the syringe's threaded rods against primary threaded rod using magnets, the syringe can be moved up or down depending on the direction of rotation of the primary rod. When a syringe is to be unloaded, the syringe assembly is separated from the painting device by, for example, pulling apart the magnets on the syringe from the corresponding magnets or ferromagnetic material on the painting device.

It is appreciated that the subject matter described herein is not limited to paint as the material to be applied to the substrate. In some embodiments, materials such as curable resins may also be used. For simplicity and conciseness, however, paint will be used as the primary example of a material suitable for use with the methods and systems disclosed herein.

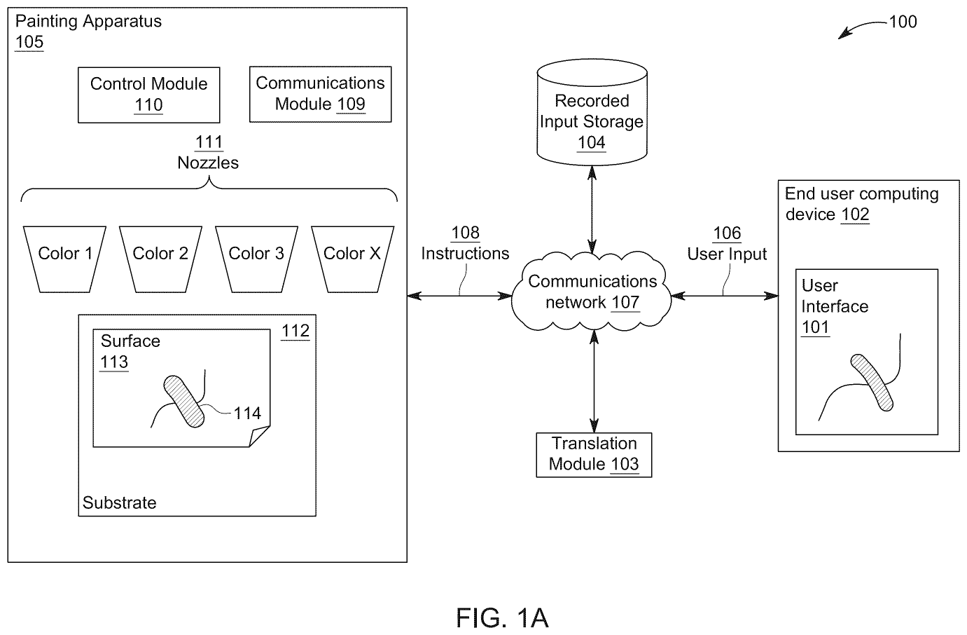

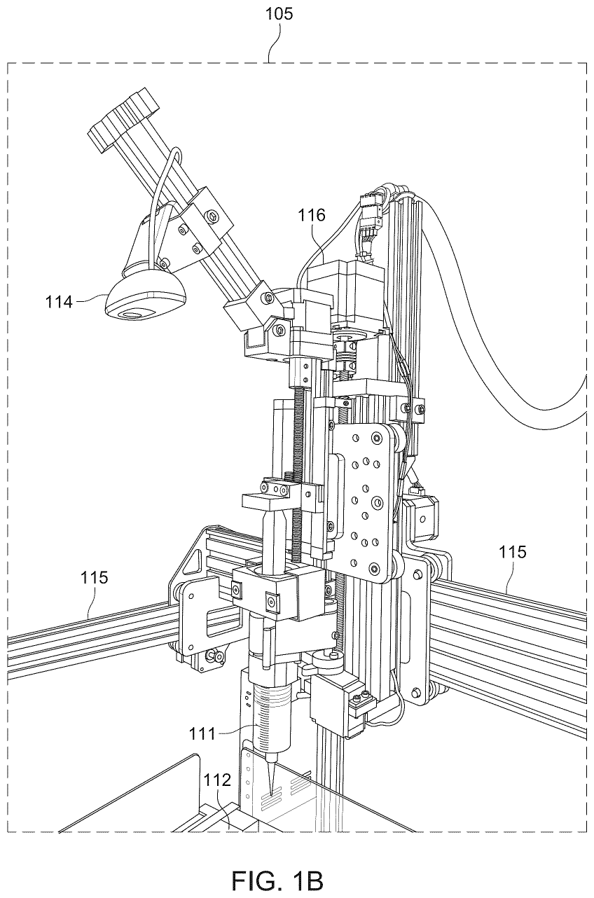

FIG. 1A is a system diagram illustrating components for remotely operating a painting device using a digital interface according to an embodiment of the subject matter described herein. Referring to FIG. 1A, the system 100 includes a user interface 101 (presented on an end user device 102), intermediary computing and communications resources (translation module 103, recorded input storage 104, communications network 107), and a painting apparatus 105 remotely located from the end user device 102.

The user interface 101 is a digital, graphical user interface for receiving user input to be translated into instructions executed by the painting apparatus. According to one embodiment, the user interface is provided via a webpage. The user may direct a browser application to a URL, optionally provide credentials for authenticating the user, and the browser may display a digital canvas or live video feed of the physical canvas.

In another embodiment, the digital user interface 101 may include a gyroscopic device. The gyroscopic device may be word, for example, on the body or clothing of the user. The gyroscopic device may also be integrated with a mobile device, such as a smartphone, and manipulated by the user.

In another embodiment, the digital user interface 101 may include a camera motion sensor. For example, the camera motion sensor may either be configured to detect the motion of one or more cameras, or may use one or more cameras to detect the motion of the cameras or other objects.

In another embodiment, the digital user interface 101 may include gyroscopic or other motion sensor integrated or associated with a mobile device. In this embodiment, the user may physically move (rotate, tilt, or translate) the mobile device in real three-dimensional space. This movement may be detected by the gyroscopic or other motion sensor and used to generate corresponding movement(s) of components of the painting device, such as the substrate table and the syringe or nozzle.

In another embodiment, the digital user interface 101 may include a direct brain-machine communications link, such as an EEG or neuralink. Such a device may be configured to receive and interpret signals produced by the user's brain as input.

In another embodiment, the digital user interface 101 may include augmented reality and/or virtual reality devices. Augmented reality (AR) combines real world and computer-generated content and can span multiple sensory modalities, including visual, auditory, haptic, somatosensory and olfactory. AR incorporates a combination of real and virtual worlds, real-time interaction, and accurate 3D registration of virtual and real objects. Overlaid sensory information can be constructive (i.e., additive to the natural environment), or destructive (i.e., masking of the natural environment). This experience is seamlessly interwoven with the physical world such that it is perceived as an immersive aspect of the real environment. Virtual Reality (VR) is a computer-generated environment with scenes and objects that appear to be real, making the user feel they are immersed in their surroundings. This environment is perceived through a device referred to as a Virtual Reality headset.

In another embodiment, the digital user interface 101 may include use of various input devices including, but not limited to, physical joysticks, audio inputs such as microphones, and pressure sensors such as floor pressure sensors for dancing.

The user may then select a virtual painting tool such as a brush, pen, or the like from a selection menu. As discussed herein, the painting tool contemplated is a syringe that ejects (e.g., squirting, dripping) paint from a nozzle located at a distal end of the syringe. Various properties may be associated with each virtual painting tool including, but not limited to, a shape, diameter, flow rate, or color. For example, the user may select a paintbrush tool having a diameter of 1 mm that provides 100 percent opacity black ink. Alternatively, the user may select a tool (e.g., airbrush) having a diameter of 5 mm that provides 50 percent opacity red ink.

The user may also select various properties of the substrate (also referred to herein as a surface, background, or canvas) including, but not limited to, its dimensions, shape, color, and texture. For example, the user may select a 24×36 inch matte white background. Alternatively, the user may select a 10-inch circular glossy black background.

In one embodiment, the substrate may be made of a material, such as a plastic sheet, suitable for vacuum forming a finished or a semi-finished art piece into a three-dimensional artwork. Vacuum forming is a post processing technique where a sheet of plastic, such as high impact polystyrene, acrylonitrile butadiene styrene (ABS), high-density polyethylene (HDPE), or other types of vacuum formable materials, is heated to a forming temperature, stretched onto a single-surface mold, and forced against the mold by a vacuum.

It is appreciated that in some embodiments, the available options for the digital background presented to the user may be the same or different from the available options for the physical background upon which the physical artwork will be produced. For example, the user may draw digitally against a white background but the physical artwork may be painted on aluminum, glass, black canvas, etc. Conversely, a representation of the actual physical surface upon which the physical artwork will be painted may be provided to the digital user interface to help the user better visualize the physical artwork produced. This may include displaying a stock image of a sheet of aluminum, glass, black canvas, etc. or may include obtaining a digital image of the actual surface the user will be painting on and transmitting the image to the user's GUI.

In some embodiments, the digital background may include a video or other images superimposed on the live video feed of the substrate. For example, a digital simulation of the process of depositing the material using the selected tools may be presented to the user in order to preview what would happen if the user were to proceed with using the selected tools. This may include illustrating digitally the movement speed of the painting device (e.g., nozzle head), how much paint will be deposited, the color of the paint, and so forth.

The user may draw a digital image in the interface using a mouse, keyboard, controller, stylus, or other suitable input device. In one embodiment, the user may click and hold down the left mouse button to draw or paint with the selected tool and may release the left mouse button to not draw or paint with the selected tool. In another embodiment, the user may use a stylus to draw or paint.

In some embodiments, it is appreciated that multiple users can work on the same substrate simultaneously. This may include multiple users, each logged into a separate instance of a browser that are all associated with the same physical painting device and substrate. User input 106 may be processed, for example, in the order in which it is received from the various users. Alternatively, the user input 106 from each user may be prioritized or otherwise ordered. For example, in a round robin method, each user may perform one input. Once a user has performed an input, control proceeds to the next user in order. It is appreciated that other ordering methods may be used without departing from the scope of the subject matter described herein for allowing multiple users to work on the same piece concurrently and transmitting information between each other via one or more servers and communication networks.

The user interface may record the user input 106. This may include recording a sequence of inputs in time order which may be stored in recorded input storage 104. The recorded inputs may include: tool selection, tool properties, tool position, tool pressure, and tool angle. For example, a user drawing with a stylus may first select a large red paint tool and paint a first stroke in the center of the canvas at a 90-degree angle to the canvas with heavy pressure. Next, the user may select a small black paint tool and paint a second stroke beginning on the left of the canvas and moving rightward and crossing the first stroke, with a brush angle of 30 degrees and light pressure. It is appreciated that if the time order of the two strokes were not maintained, the artist's intention for the black second stroke to overlay and partially obscure the red first stroke would not be accurately reproduced. As the number of strokes increases, any out-of-ordering of strokes may produce radically different artwork than the artist intended. As such, the input sequence is recorded and executed (or replayed) in the same time sequence with which it was input by the user.

In some embodiments, replaying commands may include timeline editing. For example, the user may perform various editing functions using video editing software, including using a timelines interface, such as splitting, copying, trimming, clipping, reordering, adjusting playback speed, etc. Timeline editing of commands to be replayed may be immediately available after the first gesture is performed because the system is always recording input and does not require manual initiation of recording the most recent gesture input.

It is appreciated that, in addition to replaying a previously recorded sequence of commands, the subject matter described herein may also be used for “remixing” the commands to create new artwork. Remixing may allow users to introduce new real time commands alongside the non-real time, delayed, previously recorded and replayed commands. For example, a previously recorded sequence of commands may include the painting device painting a red triangle (e.g., begin red paint at location 1, move to location 2, move to location 3, move to location 1, stop red paint). In a remix scenario, while this sequence is being replayed, the user may, for example, alter the paint color such that the corners of the triangle are red but the edges of the triangle are blue (e.g., begin red paint at location 1, move to location 2, blue paint for 5 seconds, move to location 3, blue paint for 5 seconds, move to location 1, blue paint for 5 seconds, stop red paint).

As used herein, a “gesture” refers to any movement or operation performed by the painting apparatus 105, based on received instructions 108, that occurs between toggling the dispensing of paint on and off. For example, a gesture may begin when the painting apparatus 105 initiates dispensing paint of a first color from a first syringe. The syringe may be horizontally translated across the substrate, its movement paused for a few seconds, and then translated vertically across the substrate, finishing when the painting apparatus 105 ceases dispensing. Thus, it may be appreciated that any switching between different syringes (e.g., colors) would separate between different gestures because no paint is dispensed when one syringe is stored in its storage location and another syringe is selected and removed from its storage location for use.

As used herein, a “motif” refers to a sequency or other collection of gestures. This allows for the user to record and/or play back a longer series of instructions executed by the painting apparatus 105 that includes, for example, toggling the dispensing of paint from the same syringe multiple times or swapping syringes. For example, a motif may include dispensing paint from a first syringe at a first location to form a small circular drip pattern on the substrate, stopping the paint dispensing, and moving the syringe to a second location to form a large circular drip pattern (in the same color). This motif includes two gestures. The first gesture is associated with the paint dispensing at the first location and the second gesture is associated with the paint dispensing at the second location because the paint dispensing is toggled on/off between the dispending at each location. This same principle may apply to switching syringes as well as motif that include any number of gestures.

The intermediary computing and communications resources may include various servers, networks, and other computing devices. For example, one or more webservers (not shown) may provide the end user interface to the user in a webpage embodiment. The instructions received via the user interface may be stored locally on the user's computer or may be transferred via the internet to a remote server or cloud computing service.

One or more communications networks 107, including WAN and LAN networks, may connect the end user's remote computing device 102 with the painting apparatus 105. Primarily, the communications network(s) 107 transmit instructions 108 from the user to the painting apparatus for translation and execution.

It is appreciated, however, that this communications link or path may also be bi-directional for providing various information from the painting device to the end user. For example, an error condition of the painting apparatus such as incorrect position calibration or malfunctioning nozzle(s) may be important to provide to the user to prevent generating further inputs that may be affected by the error condition. In addition to error conditions, a live, real time, or near real time image of the painting apparatus may also be transmitted to the user so the user can view the results of their inputs in real time, or near real time.

The system disclosed herein may be implemented as a client/server type architecture but may also be implemented using other architectures, such as cloud computing, software as a service model (SaaS), a mainframe/terminal model, a stand-alone computer model, a plurality of non-transitory lines of code on a computer readable medium that can be loaded onto a computer system, a plurality of non-transitory lines of code downloadable to a computer, and the like.

The system may be implemented as one or more computing devices that connect to, communicate with and/or exchange data over a link that interact with each other. Each computing device may be a processing unit-based device with sufficient processing power, memory/storage and connectivity/communications capabilities to connect to and interact with the system. For example, each computing device may be an Apple iPhone or iPad product, a Blackberry or Nokia product, a mobile product that executes the Android operating system, a personal computer, a tablet computer, a laptop computer and the like and the system is not limited to operate with any particular computing device. The link may be any wired or wireless communications link that allows the one or more computing devices and the system to communicate with each other. In one example, the link may be a combination of wireless digital data networks that connect to the computing devices and the Internet. The system may be implemented as one or more server computers (all located at one geographic location or in disparate locations) that execute a plurality of lines of non-transitory computer code to implement the functions and operations of the system as described herein. Alternatively, the system may be implemented as a hardware unit in which the functions and operations of the back-end system are programmed into a hardware system. In one implementation, the one or more server computers may use Intel® processors, run the Linux operating system, and execute Java, Ruby, Regular Expression, Flex 4.0, SQL etc.

In some embodiments, each computing device may further comprise a display and a browser application so that the display can display information generated by the system. The browser application may be a plurality of non-transitory lines of computer code executed by a processing unit of the computing device. Each computing device may also have the usual components of a computing device such as one or more processing units, memory, permanent storage, wireless/wired communication circuitry, an operating system, etc.

The system may further comprise a server (that may be software based or hardware based) that allows each computing device to connect to and interact with the system such as sending information and receiving information from the computing devices that is executed by one or more processing units. The system may further comprise software- or hardware-based modules and database(s) for processing and storing content associated with the system, metadata generated by the system for each piece of content, user preferences, and the like.

In one embodiment, the system includes one or more processors, server, clients, data storage devices, and non-transitory computer readable instructions that, when executed by a processor, cause a device to perform one or more functions. It is appreciated that the functions described herein may be performed by a single device or may be distributed across multiple devices.

When a user interacts with the system, the user may use a frontend client application. The client application may include a graphical user interface that allows the user to select one or more digital files. The client application may communicate with a backend cloud component using an application programming interface (API) comprising a set of definitions and protocols for building and integrating application software. As used herein, an API is a connection between computers or between computer programs that is a type of software interface, offering a service to other pieces of software. A document or standard that describes how to build or use such a connection or interface is called an API specification. A computer system that meets this standard is said to implement or expose an API. The term API may refer either to the specification or to the implementation.

Software-as-a-service (SaaS) is a software licensing and delivery model in which software is licensed on a subscription basis and is centrally hosted. SaaS is typically accessed by users using a thin client, e.g., via a web browser. SaaS is considered part of the nomenclature of cloud computing.

Many SaaS solutions are based on a multitenant architecture. With this model, a single version of the application, with a single configuration (hardware, network, operating system), is used for all customers (“tenants”). To support scalability, the application is installed on multiple machines (called horizontal scaling). The term “software multitenancy” refers to a software architecture in which a single instance of software runs on a server and serves multiple tenants. Systems designed in such manner are often called shared (in contrast to dedicated or isolated). A tenant is a group of users who share a common access with specific privileges to the software instance. With a multitenant architecture, a software application is designed to provide every tenant a dedicated share of the instance—including its data, configuration, user management, tenant individual functionality and non-functional properties.

The backend cloud component described herein may also be referred to as a SaaS component. One or more tenants which may communicate with the SaaS component via a communications network, such as the Internet. The SaaS component may be logically divided into one or more layers, each layer providing separate functionality and being capable of communicating with one or more other layers.

Cloud storage may store or manage information using a public or private cloud. Cloud storage is a model of computer data storage in which the digital data is stored in logical pools. The physical storage spans multiple servers (sometimes in multiple locations), and the physical environment is typically owned and managed by a hosting company. Cloud storage providers are responsible for keeping the data available and accessible, and the physical environment protected and running. People and/or organizations buy or lease storage capacity from the providers to store user, organization, or application data. Cloud storage services may be accessed through a co-located cloud computing service, a web service API, or by applications that utilize the API.

The painting apparatus 105 may include a communications module 109 for sending and receiving instructions 108 and other data, one or more nozzles 111, paint (shown as Colors 1 through X), a pressure generator (not shown), a substrate 112, devices for controlling the spray nozzles (control module 110), and optionally devices for controlling the substrate and one or more cameras or other sensors.

Generally, a surface 113 to be painted is placed and secured to the substrate 112. The substrate 112 may be composed of wood, metal, or other suitable rigid material that is substantially flat and larger than the surface 113 to be painted. This allows for paint to be applied up to and beyond the edge of the surface 113 to be painted (and onto the substrate 112) to obtain a smoother paint application 114 up to and including edges of the surface 113.

The surface 113 to be painted may be paper, metal, glass, plastic, linen, or any other physical material or object. In most embodiments, the surface to be painted includes a flat, rectangular canvas.

The canvas 113 may be secured to the substrate 112 via any suitable method including, but not limited to, compression, tension, gravity, adhesive, magnets, and staples. For example, a sheet of paper may be secured to the substrate using magnets or adhesive tape placed at each corner. In another example, a canvas 113 stretched over a rigid wood frame may be secured to the substrate 112 by placing the canvas frame inside of top and bottom clamps.

One or more nozzles 111 may be located above and substantially perpendicular to the substrate 112 for spraying the paint onto the surface 113. In one embodiment, paint is expelled from the nozzles 111 using pressure. In one embodiment, this includes using a stepper motor to depress a plunger located at a distal end of a syringe for squeezing the paint from the syringe and out a nozzle located at an opposite end of the syringe. This may also include spraying the paint particles through the air using compressed gas—usually air—to atomize and direct the paint particles.

The volume and pressure used may be adjusted depending on various aspects, such as the viscosity of the paint or the desired transfer efficiency (amount of coating that ends up on the target surface).

For example, a high-volume low-pressure (HVLP) nozzle uses a compressor to supply the air to a spray gun that requires a lower pressure. The higher volume of air is used to aerosolize and propel the paint at lower air pressure, resulting in a higher proportion of paint reaching the target surface with reduced overspray, materials consumption, and air pollution.

In another example, a low volume low pressure (LVLP) nozzle operates at a lower pressure but uses a low volume of air compared to conventional and HVLP equipment, resulting in increased transfer efficiency while decreasing the amount of compressed air consumption.

One embodiment of the nozzle includes a micro syringe pump and controller, the syringe having a diameter of approximately 50 mm and a stroke of 150 mm capable of applying between 1 and 150 ml of paint. The syringe may be composed of high-strength acrylic. The controller may apply a push-pull force of approximately 60N using a stepper motor at a maximum speed of 150 mm/min.

One or more nozzles 111 may be controlled individually or in groups. In one embodiment, each nozzle may be associated with a different color paint. In some cases, only nozzle(s) associated with a single color may be activated at a time. In other cases, nozzle(s) associated with multiple different colors may be activated together to create a mixture of the colors. In yet other cases, multiple nozzle(s) may be activated simultaneously located at different parts of the surface such that the application of paint from one nozzle or group of nozzles is independent (not affected) by the application of paint from another nozzle or group of nozzles. This may speed up the paint application process.

The movement and position of the one or more nozzles 111, and optionally the substrate 112, may be controlled by one or more devices such as a CNC subsystem. Computer numerical control (CNC) is the automated control of tools by means of a computer. A CNC machine follows coded programmed instructions without a manual operator directly controlling the machining operation. A CNC machine is a combination of a motorized, maneuverable tool and often a motorized, maneuverable platform, both of which are controlled by a computer according to specific input instructions. The instructions can be provided to a CNC machine in the form of a sequential program of machine control instructions, such as G-code and M-code, and then executed.

Motion is controlled in multiple axes, including but not limited to horizontal and vertical axes (X and Y) and depth axis (Z). Additionally, the angle of the nozzle relative to the substrate may be controlled such that paint can be applied directly to the surface (90 degrees) or obliquely up to parallel to the surface (<0 degrees).

The position of the tool may be driven by direct-drive stepper motors or servo motors to provide highly accurate movements. In numerical control systems, the position of the tool may be defined by a set of instructions. Positioning control is performed using either an open-loop or a closed-loop system. In an open-loop system, communication takes place in one direction only: from the controller to the motor. In a closed-loop system, feedback is provided to the controller so that it can correct for errors in position, velocity, and acceleration.

The position of the tool may be based on a three-dimensional Cartesian coordinate system. Absolute coordinates represent the (0,0,0) point on the plane as a starting point or “home position” before starting.

In contrast to conventional methods and systems which use machines to recreate a digital image on a physical surface, the present invention provides for real time or near real time remote operation of the physical painting apparatus. For example, the user may log onto the system via their browser. At another location, the painting apparatus may be prepared for beginning painting. This may include calibrating the position of the nozzles, selecting and filling the paint colors for each nozzle, securing the canvas to the substrate, and so on. When the user begins to digitally paint in the browser user interface, one or more inputs are recorded and transmitted to the painting device over one or more communications networks, such as the internet. These inputs are automatically translated in real time or near real time into instructions that can be executed by the painting apparatus. The translation between user input and executable instructions may be performed locally at an end user device (e.g., local PC or browser), by an intermediary server (e.g., cloud server), or at a device co-located with the painting apparatus. Thus, rather than receiving a completed digital image and then reproducing the image on the canvas, the present invention allows the user to remotely control the painting apparatus remotely and in real time or near real time.

In some embodiments, translation between user input and executable instructions may be performed using machine learning to optimize the accuracy of the physical artwork compared with the digital artwork by examining prior results either from the same user or from a corpus of multiple users.

Machine learning (ML) is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, in which certain metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

FIG. 1B is a perspective view illustrating an exemplary painting device according to an embodiment of the subject matter described herein. Referring to FIG. 1B, painting device 105 may include a digital camera 114 or other optical capture device aimed at the substrate 112 for monitoring the movement of the syringe 111 as it dispenses paint onto the substrate 112. Translation of the syringe's location in two directions in the same plane, such as X and Y axes, may be performed using linear structural members 115 (also referred to as the “syringe gantry”). Dispensing of paint from the syringe 111 may be performed by pressing the plunger of the syringe. The plunger may be operatively coupled with a flat surface of a grip-release-actuation assembly within which the syringe is secured. Two threaded rods on the grip-release-actuation assembly are interwoven with corresponding threads on a threaded drive shaft of the painting device 105. The threaded drive shaft may be rotated using a stepper motor 116 or similar means. When the threaded drive shaft is rotated, the threads cause the two fixed threaded rods, and thus the flat surface of a grip-release-actuation assembly within which the syringe is secured, to be moved downward thereby depressing the plunger of the syringe 111.

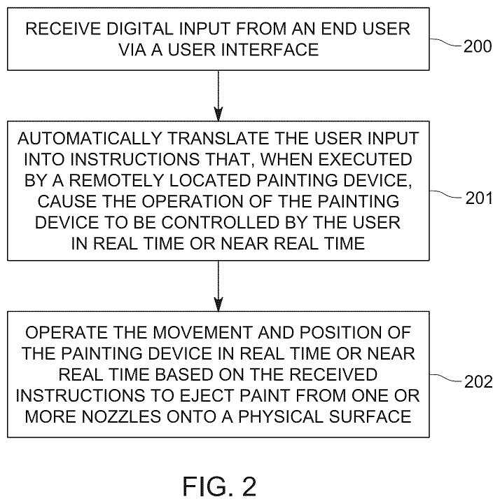

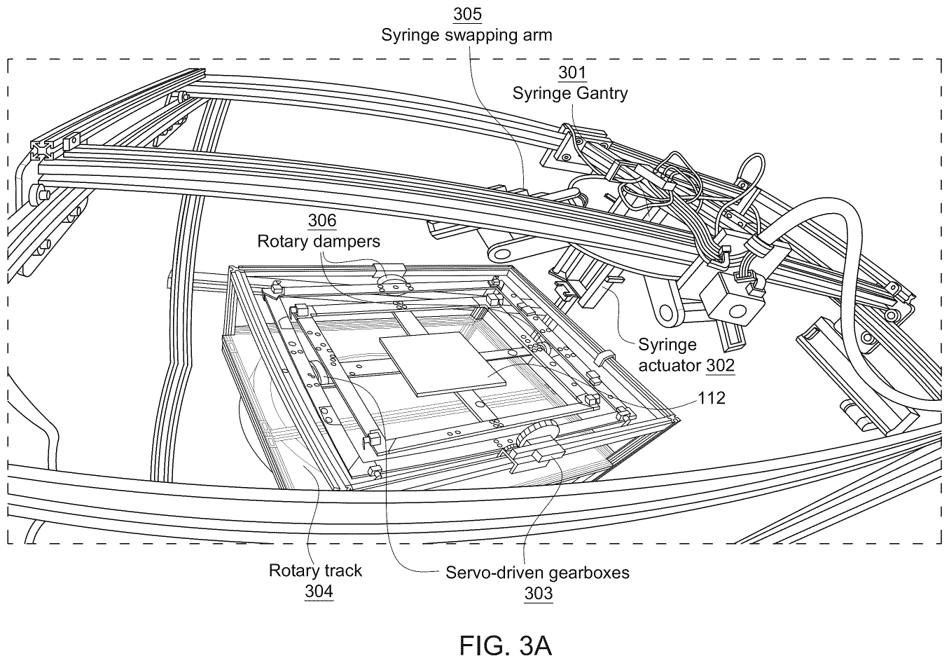

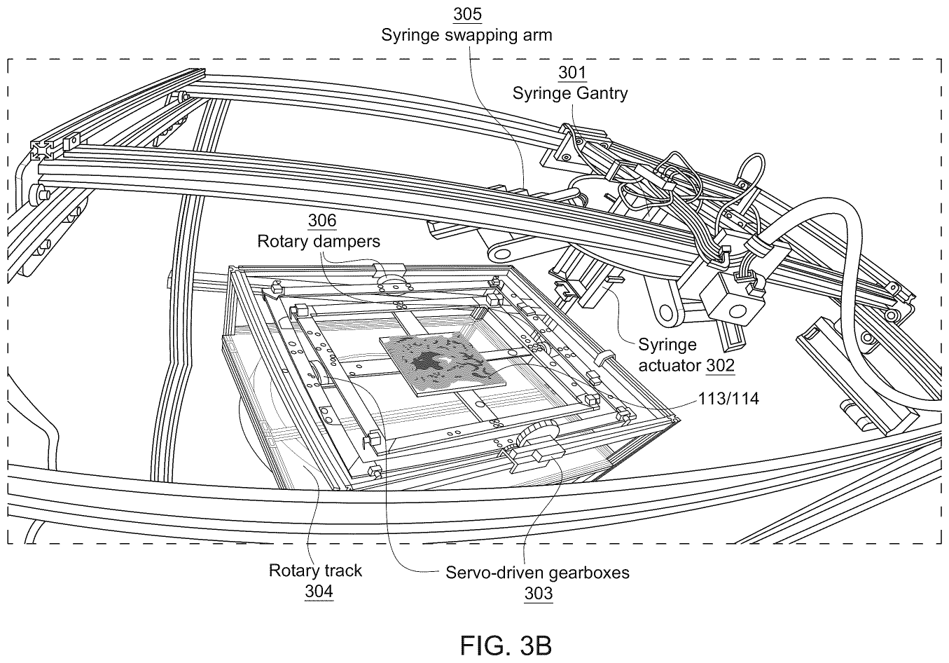

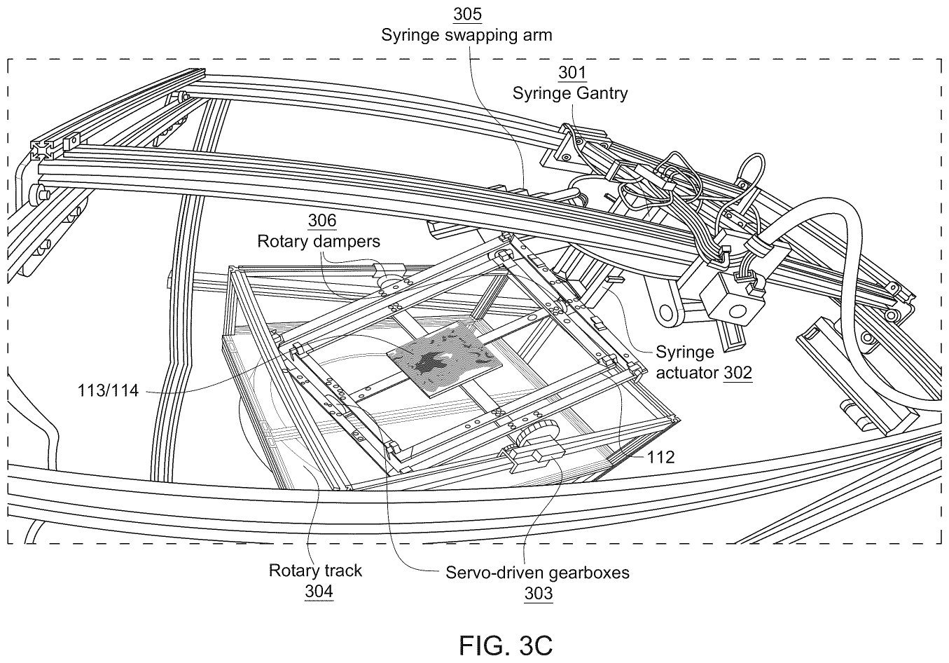

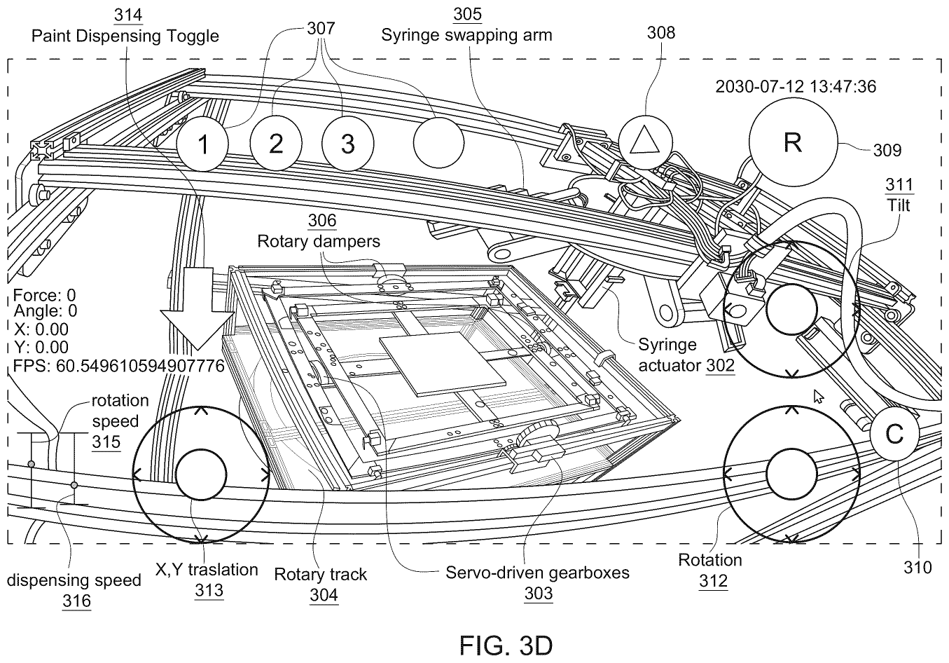

FIG. 2 is a flow diagram illustrating steps for remotely operating a painting device according to an embodiment of the subject matter described herein. Referring to FIG. 2, at step 200 digital input is received from an end user via a user interface. As will be discussed herein with respect to FIG. 3, the user interface may include a browser page that displays a real time or near real time video feed of the painting device and the substrate and/or surface to be painted. The video feed may include video feeds from one or more cameras co-located with the painting device. The user may select from among multiple video feeds depending on their needs. For example, a top down view of the surface to be painted may be displayed full screen to aid the user in viewing the artwork as it is painted. In other embodiments, the user interface may include a mobile app, dedicated desktop app, or the like.

At step 201, the received user input may be automatically translated into instructions that when executed by the remotely located painting device causes the operation of the painting device to be controlled by the user. For example, user input may include a selection of a color and an indication to begin painting. Thereafter, the user may use either on or off-screen joystick controls to control the movement of the painting nozzle in a variety of axes. This may include moving the nozzle in the X or Y axes, as well as the angle or rotation of the nozzle. The speed of the movement of the nozzle may also be controlled by the user.

These inputs may be recorded in sequence and translated into G-code or other instructions executable by the painting device. The user inputs may be a timestamped list of vectors. It is appreciated that the user inputs and/or the translated instructions may be played back later in order to reproduce the artwork created in real time by the user.

Additionally, in some embodiments, a portion of the user input may be reproduced in other portions of the surface or at varying time intervals (e.g., faster or slower than the original timestamped time intervals). For example, a user may manually paint a first quadrant of the surface with a design. This input may be recorded and used to reproduce the same design for other quadrants of the same surface. This allows the user to blend manually created artwork with computer-assisted symmetry or other advantages.

At step 202, the movement and position of the painting apparatus is operated in real time or near real time based on the revived instructions to eject paint from one or more nozzles onto a physical surface. For example, a plurality of syringes, each containing a different color paint, may be accessible via a carousel. The G-code instructions may be executed by a CNC machine including one or more micro controller units to move the syringe of a selected color to a desired position above the surface to be painted and depress a plunger of the syringe using a stepper motor to eject paint from the syringe onto the surface at the desired location. This process can be repeated for each instruction in sequence in order to produce a physical artwork.

In a scenario where the user is controlling operation of the syringes in real time, it is appreciated that the painting device will wait and only execute an instruction as a direct and immediate result of user input using the remote digital user interface.

In a scenario, however, where the user has already created an artwork and their input sequence has been recorded, it is appreciated that the painting device may execute the instruction sequence that is now an indirect and delayed result of user input recorded using the digital interface. In either scenario, however, creation of the initial sequence of user inputs and execution of translated instructions for creating a physical artwork is performed in real time or near real time by the end user.

In some embodiments, the paint or other material deposited by the painting device may be manipulated after deposition. For example, a high velocity fan and/or a heating element may be used to dry or blow material deposited on the substrate. This allows the user another way to create artwork by depositing wet material and subsequently selectively manipulating said material. In another example, a magnetic ball may be dragged across the substrate to move, smear, mix, or otherwise manipulate a previously deposited material.

In other embodiments, the substrate may be a non-flat surface. For example, the substrate may include a geographical relief, a saddle shape, a dome shape, and so forth. This allows for a wider variety of artistic expression. A first material (e.g., color of paint or curable resin) may be deposited at lower elevations of a geographic relief indicating a body of water and a second material may be deposited at higher elevations of the geographic relief indicating trees or snow.

FIG. 3A is a diagram illustrating a perspective view of the painting apparatus according to an embodiment of the subject matter described herein. Referring to FIG. 3A, the painting apparatus may generally be divided into various components, systems, and assemblies for physically manipulating one or more paint nozzles in physical three-dimensional space and various components, systems, and assemblies for physically manipulating the substrate and surface to be painted which is mounted thereto in physical three-dimensional space.

For example, syringe gantry 301 is a moving platform that allows the tools to be translated in two axes of motion (e.g., X, Y). Syringe actuator 302 is an assembly that enables the syringe contents to be dispensed or withdrawn. Servo-driven gearboxes 303 convey rotational motion from the servos to the tilt table. Tilt table rotary track 304 is a system of ball bearings, gears, and drive motor to rotate the tilt table in clockwise or counterclockwise directions. Syringe swapping arm 305 is an assembly with two degrees of freedom (e.g., produced using two servo motors) that can place a currently loaded syringe back into a predefined location in a holding rack and load another syringe from another predefined location in the holding rack. It is appreciated that in other embodiments, a rotary carousel may be used instead of a rack. Rotary dampers 306 slow down the rotary motion provided by the servos to make it smoother and prevent oscillations. The dual axis tilt table is a servo-driven table that can be tilted from +90 to −90 degree along two axes (u and v). A syringe rotary track provides precise rotation to enable swapping between different syringe arms.

FIG. 3B is a diagram illustrating the exemplary painting device of FIG. 3A after paint has been applied to the substrate according to an embodiment of the subject matter described herein. Referring to FIG. 3B, it may be appreciated that a surface 114 has been placed on top of, or secured to, the substrate 112 onto which paint 114 has been applied. It may be further appreciated that the servo-driven dual axis tilt table that determines the orientation of the substrate 114 is in a neutral position. That is, the tilt table is flat and not rotated or tilted in any direction or axis.

FIG. 3C is a diagram illustrating the exemplary painting device of FIG. 3B where the substrate is tilted one or more axes according to an embodiment of the subject matter described herein. As shown in FIG. 3C, the servo-driven dual axis tilt table has been tilted in both the u and v axes such that the back or far corner is in an elevated position compared to the neutral or flat position shown in FIG. 3B. Similarly, the right corner of the dual axis tilt table is in an elevated position relative to neutral, but not as elevated at the far corner. Conversely, the left and near corners of the dual axis tilt table are in a lowered position. This dual axis tilt of the substrate allows the user an additional means for controlling the application of paint into the surface. For example, the user may apply paint to the far corner of the surface, stop dispensing paint, and then tilt the table/surface in the manner shown in FIG. 3C to allow gravity to bring at least some of the paint applied to the far corner toward the near corner (or any direction desired by the user). By controlling the amount of tilt, the speed with which the tilt is obtained, and the length the table is tilted, the user can control how paint moves across the surface.

FIG. 3D is a diagram illustrating an exemplary user interface for remotely operating a painting device according to an embodiment of the subject matter described herein. Referring to FIG. 3D, a live video feed of the painting device including the surface to be painted is shown. Various on-screen buttons may be displayed to the user via the user interface for controlling the painting device.

For example, buttons 307 labeled 1, 2, 3 may be used to select different syringes/colors of paint. When a first button is selected, for example by clicking on the button within the user interface by left clicking a mouse, syringe swapping arm 305 may grab and load the selected syringe from a syringe holding rack where each syringe is held in place in the rack using magnets at predefined locations. In another embodiment, a carousel containing syringes having different colors of paint contained therein may be rotated into position above the surface. Paint dispensing toggle button 314 may be clicked to begin painting and either the same button may be clicked again to stop painting or a different button may be used to stop painting.

Various on-screen joystick controls may also be used to control the movement and position of the painting device, specifically the syringe of the selected color. For example, the user may click and drag (or use an analog controller) to move the syringe up, down, left, right, and so on. Here, phaser joystick 313 is used to control movement of the syringe (e.g., translation in the X and Y axes), phaser joystick 311 is used to control the rotation of the syringe, and phaser joystick 311 is used to control the tilt of the syringe.

A separate on-screen control may be used to adjust the height or depth of the syringe corresponding to the distance of the syringe from the surface. Additionally, on-screen slider 315 may be used to control rotation speed and slider 316 may be used to control dispensing speed. For example, by dragging slider 315 up, when the user rotates the syringe with joystick 312, the syringe may rotate quickly (e.g., 20 rotations per minute) and, conversely, by dragging slider 315 down, when the user rotates the syringe with joystick 312, the syringe may rotate slowly (e.g., 1 rotation per minute). Similarly, by dragging slider 316 up, when the user dispenses paint using toggle 314, the syringe plunger may be depressed quickly (e.g., 0.25 inches per second) and, conversely, by dragging slider 316 down, when the user dispenses paint using toggle 314, the syringe may plunger be depressed slowly (e.g., 0.1 inch per minute). It is also appreciated that, in other embodiments, rather than separate controls for movement and movement speed, the user may increase the speed at which the syringe moves by moving the on-screen joystick(s) farther to the outside of the circle or keep the joystick(s) closer to the center of the circle to use a slower movement speed.

In one embodiment, the front-end software may include React alongside Phaser to provide the user with a simple way to interact with the ERAS system. React is a software library for web and native user interfaces that lets users create user interfaces from components. React components are JavaScript functions. React lets users build user interfaces out of individual pieces called components. Users can create React components like Thumbnail, LikeButton, and Video, and then combine them into entire screens, pages, and apps. Phaser is a software framework used for making HTML5 applications on desktop and mobile. Phaser uses both a Canvas and WebGL renderer internally and can automatically swap between them based on browser support. This allows for fast rendering across desktop and mobile. Phaser uses the Pixi.js library for rendering. It is appreciated, however, that other software components, libraries, or functions may also be used (in place of or in addition to React and Phaser) without departing from the scope of the subject matter described herein.

Referring to FIG. 3D, virtual joysticks 311, 312 may be used to control the X and Y axes via jogging. Buttons 307 may be used to swap to different syringes. For example, the ability to select between four possible syringes is depicted by four circular buttons 307 yet only the first three buttons (labeled 1, 2, 3) may be associated with syringes. As mentioned previously, slider 315 may be used to set rotation speed and direction of the selected syringe and/or the substrate and slider 316 may be used to toggle dispensing and set speed. For example, after selecting a first syringe containing a first color and positioning the syringe at a target location above the substrate, the user may begin slowly dispensing a small amount paint from the syringe. Then, after selecting a second syringe containing a second color and positioning the syringe at a target location above the substrate, the user may begin quickly dispensing a large amount paint from the syringe. This different toggling of dispensing and controlling of set speed is based on user input provided to via the UI. A tilt button 311 may be used to for tilting of the table based on DeviceOrientation (the angle at which the phone or tablet is being held).

The UI may also include a Replay Gesture Dialog button 309. In one embodiment, the system is always recording the most recent gesture performed. That way, the user does not have to manually initiate recording of each gesture they may wish to replay. When the user selects Replay Gesture Dialog button 309, the system may replay a gesture with, or without, additional modifications. A gesture may be a sequence of movements or instructions to be provided to the painting apparatus. In addition to, for example, an instruction for moving a syringe from a first position to a second position, a gesture may also include an indication of time associated with the movements. This allows the system to differentiate between two gestures that may have the same movements but perform those movements over different periods of time. For example, paint dispensed from two different syringes, each at the same dispensing rate and each moving from the same starting position and to the same ending position, where one syringe completes this movement in one second and the other syringe completes this movement in thirty seconds will produce different amounts of paint on the substrate.

Example modifications to a gesture may include performing the gesture with a different syringe or rotating the table by a given angle. For example, a gesture may include painting a vertical stripe of white paint from a first syringe. The user may replay the gesture but use blue paint from a second syringe instead.

Record/replay motif button 308 is similar to replay gesture button 309 except it also records motifs, which are most commonly associated with syringe swaps as discussed previously.

In one embodiment, the system can support multiple users simultaneously. If more than one user has joined the same session, the UI may update so that each user is in control of different parts of the system. For example, the UI may allow one user to control tilt and rotation and allow another user to control dispensing and syringe selection. In another embodiment, UI updates may be based on messages received from python motion control app.

In another embodiment, if the user's device is a desktop computer rather than a phone, tablet, or other touch-sensitive device, the UI may be controlled by a physical keyboard attached to the desktop computer. For example, the UP and DOWN arrow keys may be used like the virtual joystick for controlling the Y axis, the D key may toggle dispensing, the number 1, 2, 3, and 4 keys may select different syringes, and so forth.

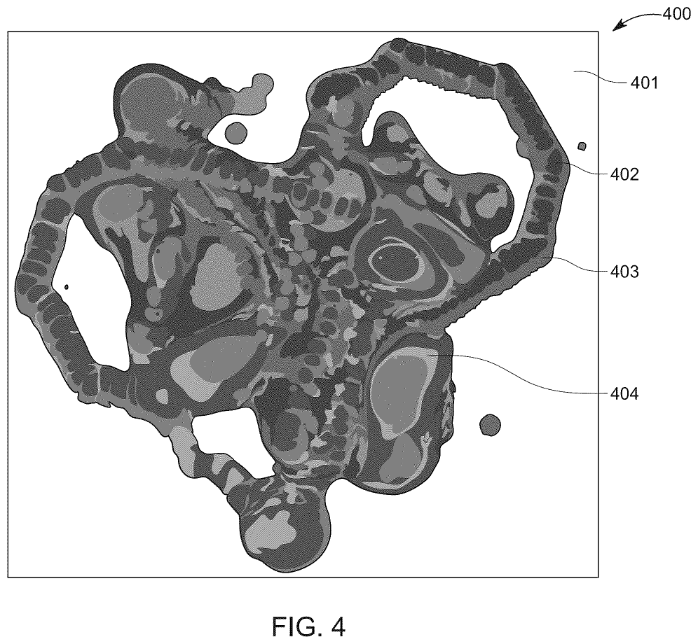

FIG. 4 is a diagram illustrating an exemplary digital image captured of a physical artwork produced by remotely operating a painting device using a digital interface according to an embodiment of the subject matter described herein. Referring to FIG. 4, the painted surface is a square canvas and the artwork painted thereon includes several layers of paint distributed across the surface and, in some cases, overlaying other layers of paint. Colors include red, purple, black, yellow, light blue, and dark blue.

A digital image of the painted surface/artwork may be captured using a digital camera that is co-located or separate from the painting device. This may allow for higher resolution digital images to be obtained than may be possible using the one or more cameras associated with the painting device used for providing a live feed to the user interface during the painting process.

Referring to FIG. 4, example artwork 400 includes a surface 401 (e.g., paper or canvas) onto which a first color paint 402 (darkest), a second color paint 403 (medium), and a third color paint 404 (lightest) are applied to the surface 401.

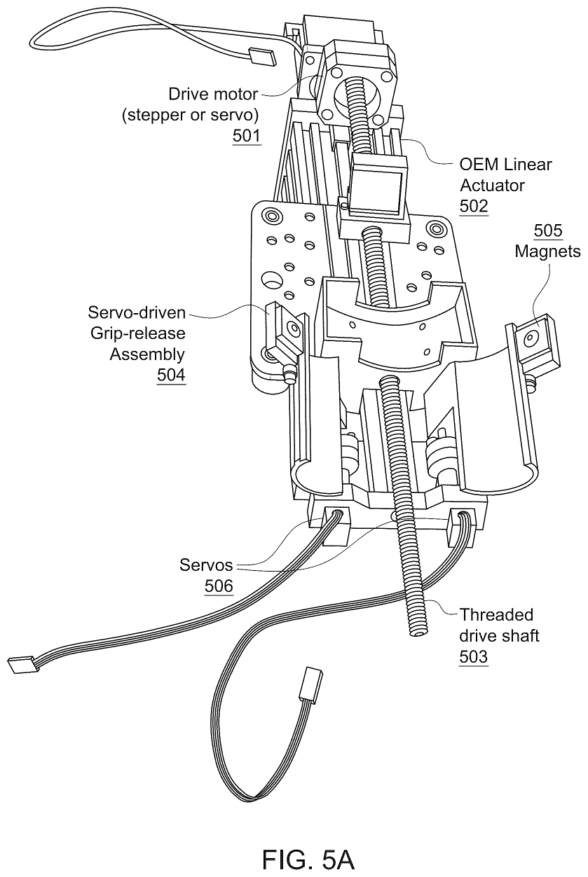

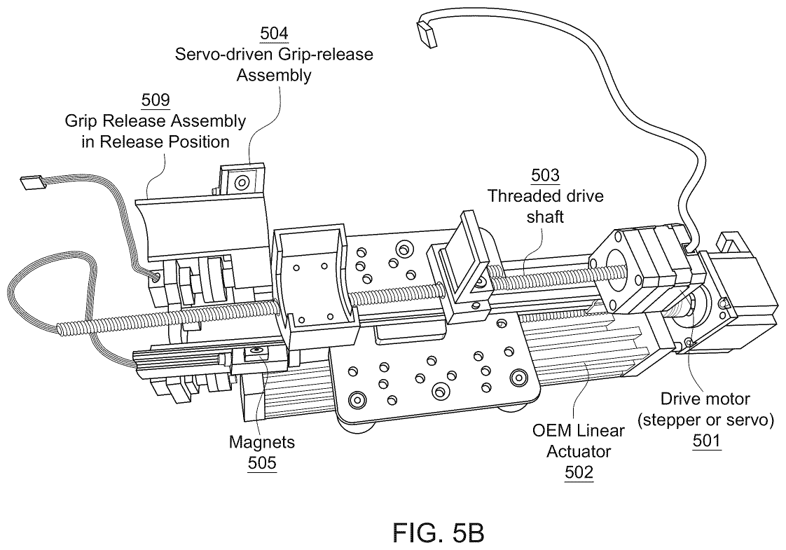

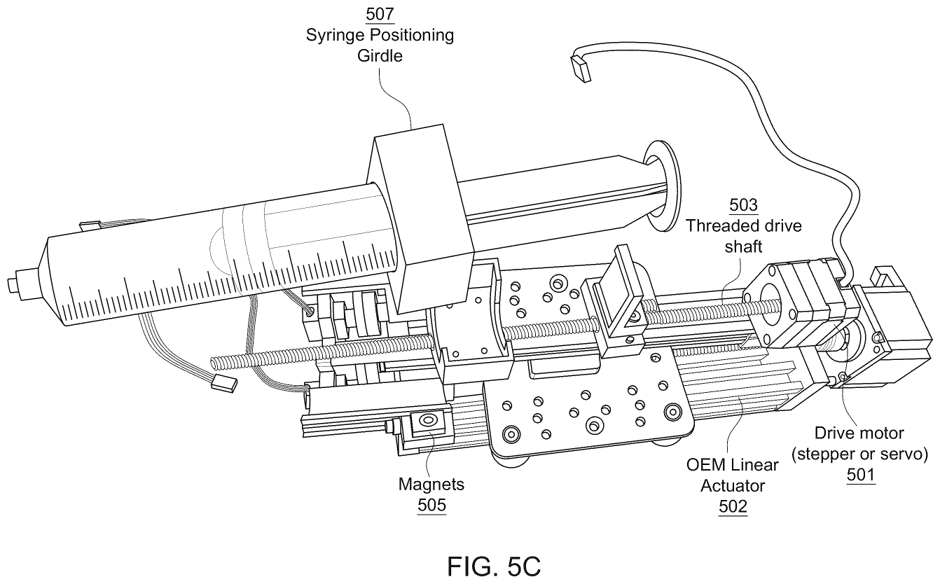

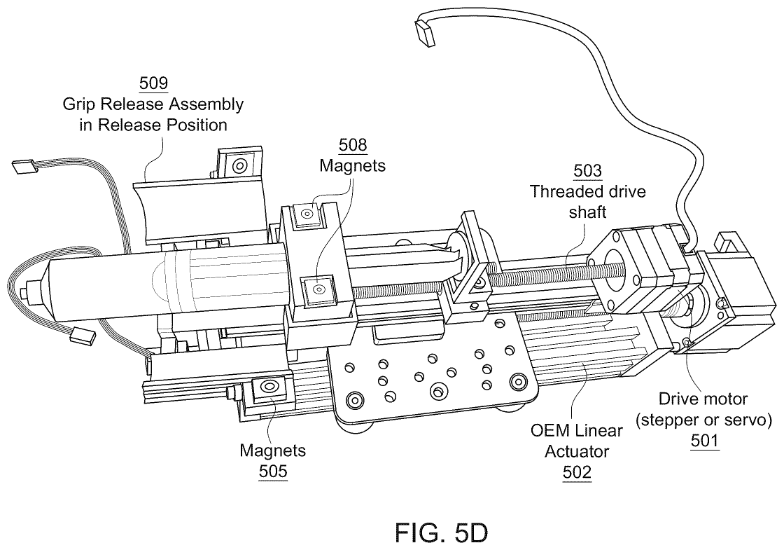

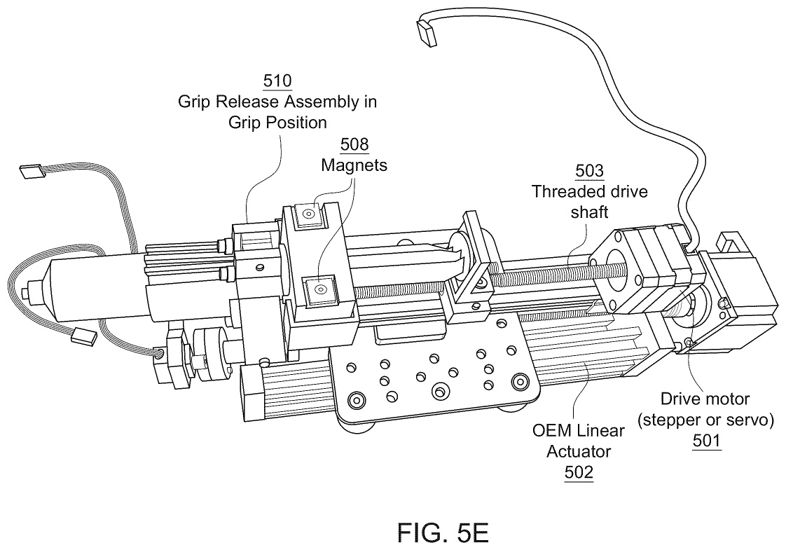

FIGS. 5A-5E illustrate a device for holding or securing an individual syringe and for expelling paint therefrom. For example, the device may include a stepper motor for depressing a plunger associated with a syringe. The device may include means for securing to a larger carousel device so that multiple devices can be pre-loaded with different colors of paint and quickly selected by the user without additional human intervention.

FIG. 5A is a diagram illustrating a perspective view of grip-release-actuator sub-assembly of the painting device according to an embodiment of the subject matter described herein. The grip-release-actuator sub-assembly includes a drive motor 501, such as a servo or stepper motor, for driving a threaded drive shaft 503. A linear actuator 502 is coupled with the threaded drive shaft 503 to move along the longitudinal axis of shaft 503. To securely hold a syringe in place, as well as to release the syringe, a servo-driven grip-release assembly 504 may be operated by servos 506. The servo-driven grip-release assembly 504 can open and close complimentary halves of an outer shell that corresponds with the size and shape of the syringe body. In the closed position, magnets 505 located on each half of the servo-driven grip-release assembly 504 prevent the servo-driven grip-release assembly 504 from accidentally being released.

FIG. 5B is a diagram illustrating a perspective view of grip-release-actuator sub-assembly of the painting device according to an embodiment of the subject matter described herein. Here, the grip-release-actuator sub-assembly of FIG. 5A is shown from a different perspective.

FIG. 5C is a diagram illustrating a perspective view of grip-release-actuator sub-assembly of the painting device according to an embodiment of the subject matter described herein. Here, a syringe having a syringe positioning girdle 507 may be inserted into the grip-release-actuator sub-assembly. The plunger of the syringe may be inserted into the actuator 502 and the girdle 507 may be secured to a corresponding housing using magnets for ensuring that the syringe is positioned correctly.

FIG. 5D is a diagram illustrating a perspective view of grip-release-actuator sub-assembly of the painting device according to an embodiment of the subject matter described herein. Here, magnets 508 are shown which are used for securing the grip-release-actuator sub-assembly to the painting device and/or a holding rack containing other syringes in predefined locations. It is appreciated that the two halves of the grip-release-actuator sub-assembly are shown in the open position and that the grip-release-actuator sub-assembly includes magnets for securing the two halves together in the close position.

FIG. 5E is a diagram illustrating a perspective view of grip-release-actuator sub-assembly of the painting device according to an embodiment of the subject matter described herein. Here, the syringe is secured within the grip-release-actuator sub-assembly by closing the two halves and securing them with magnets or other means.

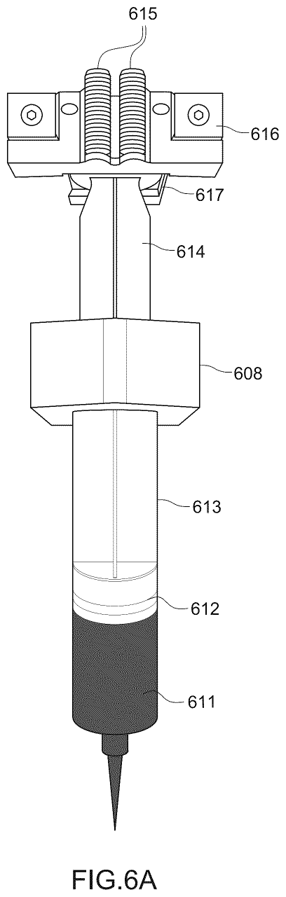

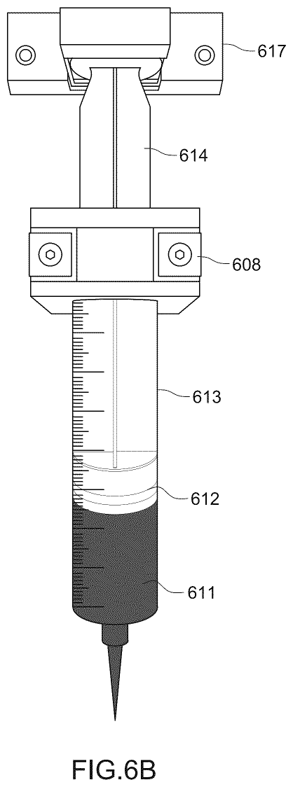

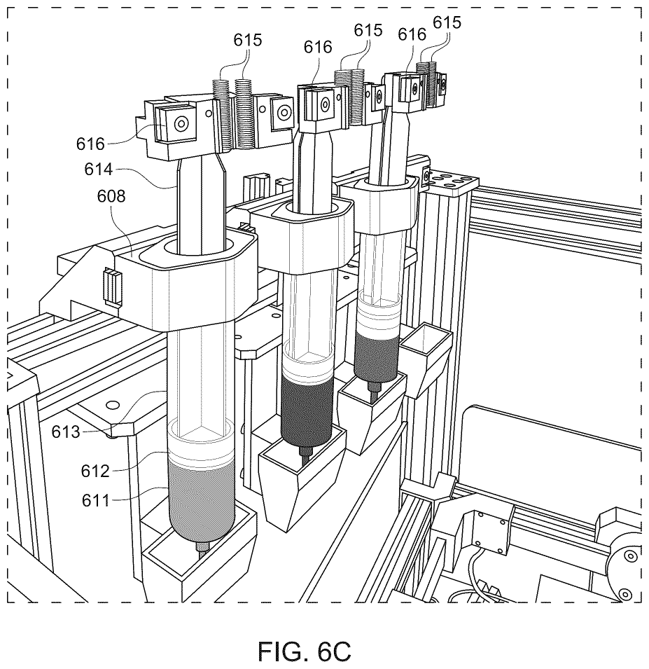

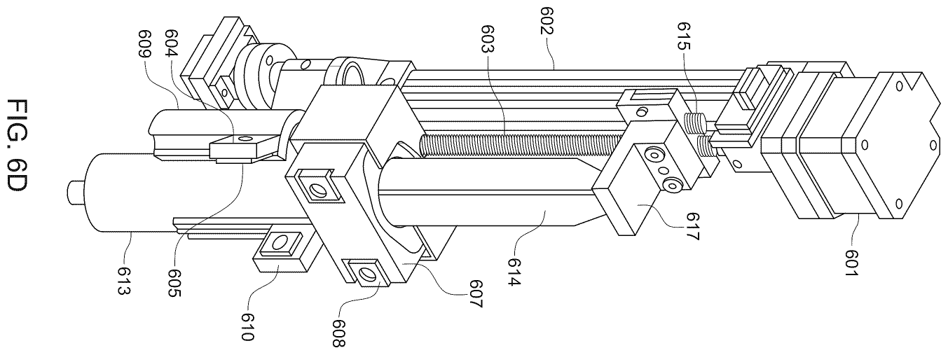

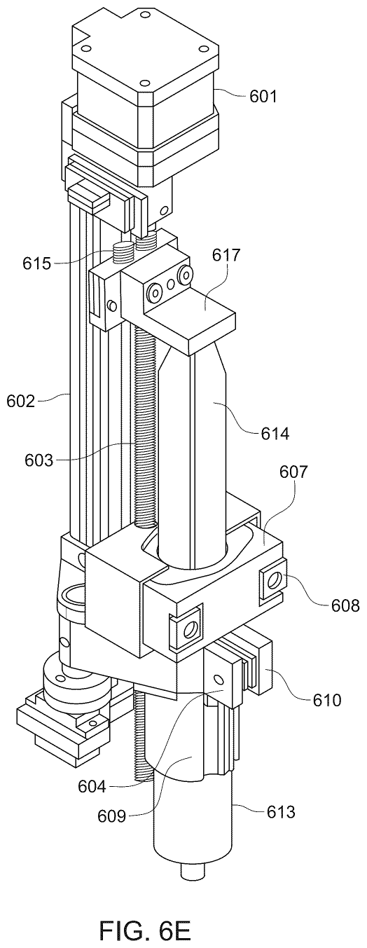

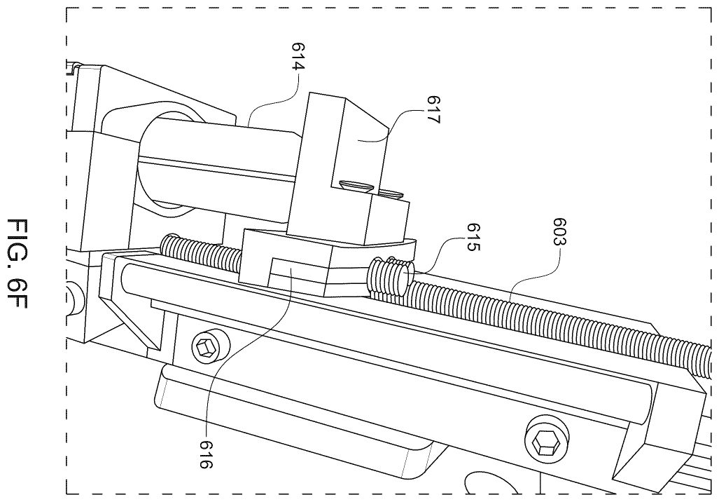

FIG. 6A is a diagram illustrating a perspective view of a syringe assembly of the painting device according to an embodiment of the subject matter described herein. Here, paint 611 is separated from the rest of the syringe body 613 by gasket 612. The syringe is associated with syringe girdle 608 and includes a plunger 614 for moving gasket 612 within the syringe body 613 for dispensing paint 611. Two fixed threaded rods 615 are located at the plunger end of the syringe and connected to a body or housing that contains two magnets. The threaded rods 615 are coupled with the threaded drive shaft of the painting apparatus and held in place to the painting apparatus using the magnets 616.

FIG. 6B is a diagram illustrating an opposite perspective view of the syringe assembly of FIG. 6A according to an embodiment of the subject matter described herein. Here, the back side of the girdle 608 is shown including two magnets. These magnets may be used to secure the girdle in the holding rack with the other syringes and/or to the painting device when loaded.

FIG. 6C is a diagram illustrating a perspective view of a syringe holding rack of the painting device according to an embodiment of the subject matter described herein. Here, three syringes are shown in a holding rack (each containing different color paint). The positioning girdle 608 of each syringe girdle is secured to a predefined location in the rack with magnets. Threaded rods 615 are shown located between magnets 616 of each syringe. Below the tip of each syringe may be a collection tray for collecting any paint drips from the syringes while stored in the rack.

FIG. 6D is a diagram illustrating a perspective view of a syringe assembly of the painting device in an open position according to an embodiment of the subject matter described herein. Here, the magnets 604 and 610 are not secured together and, thus, the syringe holding device is in the open position.

FIG. 6E is a diagram illustrating a perspective view of a syringe assembly of the painting device in a close position according to an embodiment of the subject matter described herein. Here, the syringe is fully secured in the closed position because the magnets 604 and 610 are secured together.

FIG. 6F is a diagram illustrating a close-up perspective view of a syringe assembly of the painting device according to an embodiment of the subject matter described herein. Here, the two threaded rods 615 on the syringe assembly are held tightly to the threaded drive rod 603 using magnets 616 of actuator 617. When the drive shaft 603 is rotated, actuator 617 moves down thereby depressing syringe plunger 614 for dispending paint. The faster the threaded drive shaft is rotated, the faster paint is dispensed.

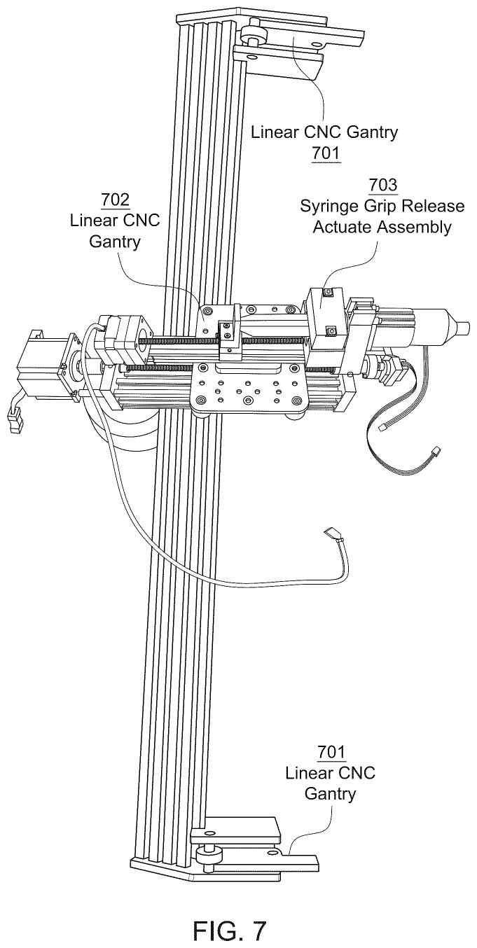

FIG. 7 is a diagram illustrating various components of the painting device according to an embodiment of the subject matter described herein. Referring to FIG. 7, a rigid elongated member having one or more grooves therein is used to secure and control the movement of the device of FIGS. 5 and 6. Using one or more micro controller units, gears, belts, or other similar means, the syringe device may be moved in a straight line along the length of the rigid elongated member. This rigid elongated member may also be attached at each end with devices for moving the rigid elongated member in a direction perpendicular to its length. This allows for the syringe device to be positioned in both a first (horizontal or X) direction/axis/dimension and in a second (vertical or Y) direction/axis/dimension based on the instructions received from the translation module which are based on the input received from the user, via the user interface, in real time or near real time.

The portion of the painting device shown in FIG. 7 includes two linear CNC gantries, one associated with linear motion in a first direction (e.g., x-axis) and another associated with linear motion in a second direction (e.g., y-axis). For example, linear CNC y-gantry 701 includes duplicate assemblies on either end of rigid elongated member 704, where each assembly includes a drive motor and belt to provide precise linear motion along the y-axis. Linear CNC x-gantry 702 keeps the z-axis stable while enabling precise linear motion along the x-axis.

Syringe grip release and actuation assembly 703 selectively grips a syringe by encompassing at least a portion of the outer body of the syringe using two corresponding rigid portions secured together with magnets. Syringe grip release and actuation assembly 703 also selectively actuates (e.g., presses the plunger) the syringe for expelling paint therefrom. A flat portion of the syringe grip release and actuation assembly 703 may press against a flat portion of the syringe plunger for actuating the syringe. Elongated member 704 may include extrusion of 8020 aluminum having a 4:1 rectangular profile that provides high stability for the overall assembly of 502 and 510.

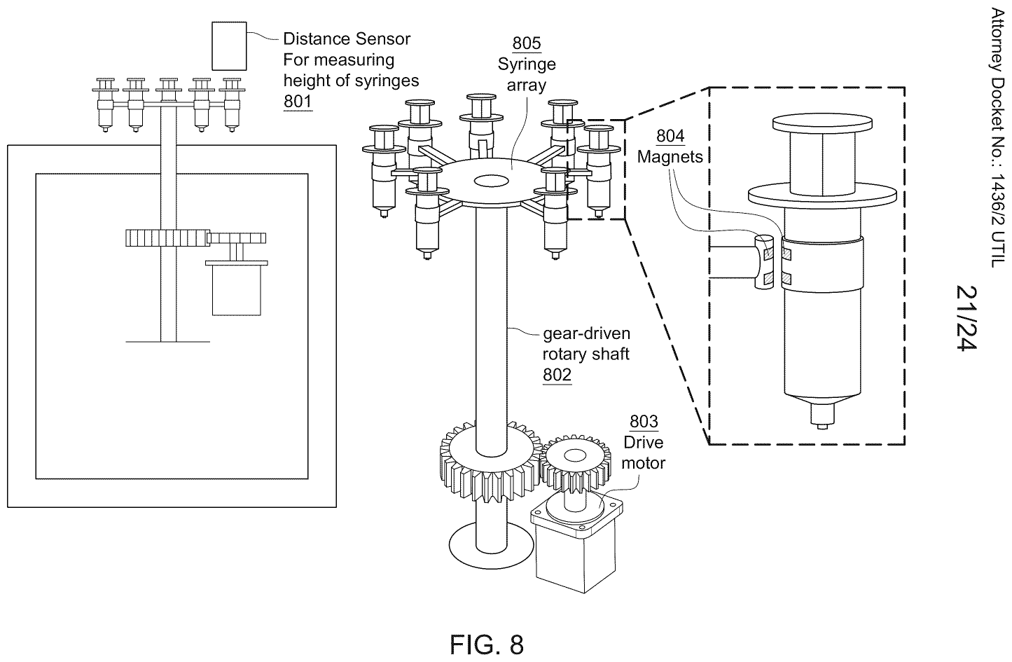

FIG. 8 is a schematic diagram illustrating an alternative syringe storage system according to an embodiment of the subject matter described herein. Referring to FIG. 8, at left is shown a side view of the painting device. At middle is shown a perspective view of the carousel portion of the painting device. The carousel contains a plurality of syringes whose selection is driven by a shared drive shaft connected to a gear and stepper motor at the distal end of the drive shaft. At right is shown a side view of a syringe inserted into a holding device or clamp that is mountable at each position in the carousel. This allows for syringes to be securely held while also allowing for quick and easy swapping of syringes, if desired, by unmounting the assembly or unclamping the syringe from the assembly.

Gear-driven rotary shaft 802 conveys rotation from the drive motor 804 to the syringe array 805. Drive motor 803 is a stepper or servo with encoder. Magnets 804 secures the syringe positioning girdle 507 to the syringe mount. Syringe array 805 is a fixed number of syringes positioned at known distances from each other that can be selected from the grip release assembly 504. The drive motor 803 rotates a precise distance to select a specific syringe. Syringe mount is a fixture that holds the syringe in place until it is needed by the system.

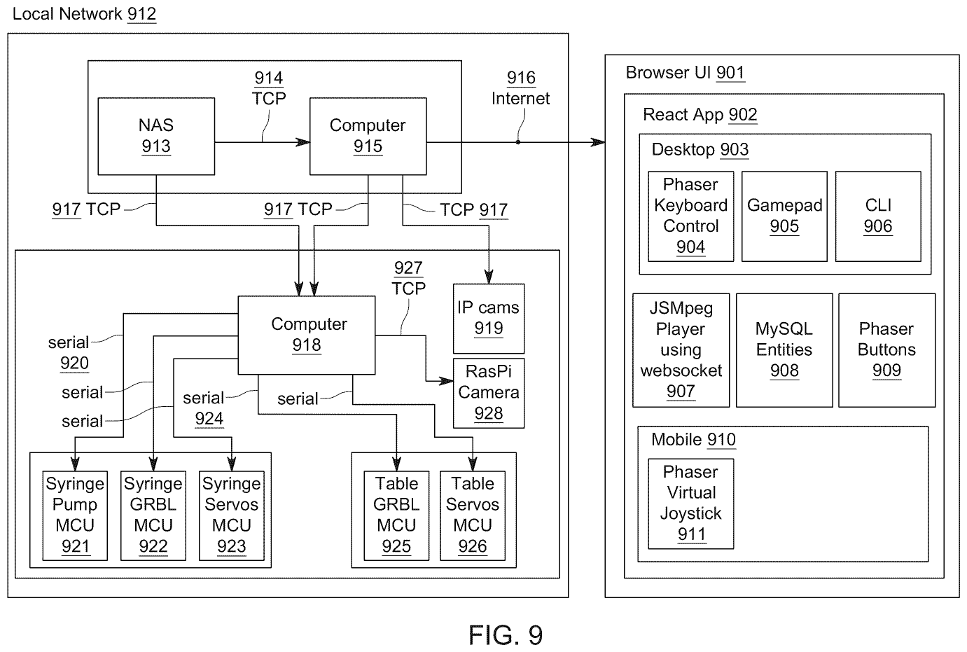

FIG. 9 is a system diagram illustrating components for remotely operating a painting device using a digital interface according to an embodiment of the subject matter described herein. Referring to FIG. 9, a browser 901 may be used to present a user interface to the user. In one embodiment, this may be programmed as a react application 902. There may be a desktop and/or mobile applications, such as desktop app 903 and mobile app 910.

On the desktop 903, various modules including a keyboard control module 904, a gamepad module 905, and a command line interface module 906 may be used for receiving user input. As discussed previously, the keyboard control module 904 may use Phaser.

On mobile 910, a virtual joystick module 911 may be used in place of a keyboard. Like keyboard control module 904, virtual joystick module 911 may also use Phaser. Additionally, various interstitial software or middleware (not shown) may be used by both mobile 910 and desktop 903 applications. For example, an mpeg player module, a SQL module, and a button module may be included.

The browser 901 may communicate over a network, such as the internet. For example, NGROK 916 or other similar cross-platform application may be used to expose local web server 915 to the internet by hosting a local web server on its own sub-domain and making the local web server 915 available on the internet through Tunnelling. Once user input is received, it may be transmitted to a remote computer 915 such as a Linux computer running MySQL server and NodeJS server.

Co-located with the Linux computer may be a network attached storage device (NAS) 913 for storing data including photos, log files, and videos. The Linux computer 915 and the NAS 913 may communicate via TCP, such as TCP link 1014.

The painting device may communicate with the Linux computer and the NAS via a LAN to a second Linux computer 918 associated with controlling the painting device. For example, a plurality of IP cameras 919 or raspberry pi cameras 928 may communicate directly with either Linux computer 918 or 915.

The second Linux computer 918 may execute Python-based motion control application and communicate with other modules. For example, a syringe control module and a table control module may communicate with the second Linux computer via one or more serial connections.

The syringe motion control module may include a syringe pump microcontroller unit (MCU) 921, a syringe GRBL MCU 922, and a syringe servos MCU 923.

Similarly, the table motion control module may include a table GRBL MCU 925 and a table servos MCU 926.

An MCU is a small computer on a single VLSI integrated circuit (IC) chip where a microcontroller contains one or more CPUs (processor cores) along with memory and programmable input/output peripherals. Program memory in the form of ferroelectric RAM, NOR flash or OTP ROM may be included on chip, as well as a small amount of RAM. Microcontrollers are designed for embedded applications. Microcontrollers provide real-time response to events in the embedded system they are controlling. When certain events occur, an interrupt system signals the processor to suspend processing the current instruction sequence and to begin an interrupt service routine (ISR, or “interrupt handler”) which will perform any processing required based on the source of the interrupt, before returning to the original instruction sequence. Possible interrupt sources are device dependent.

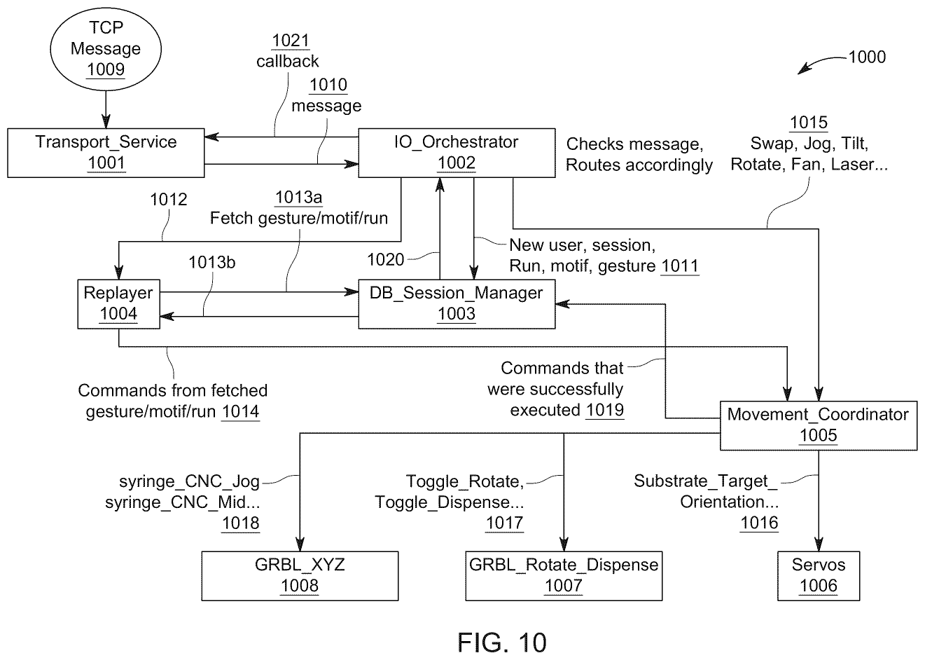

FIG. 10 is a diagram illustrating functions of an exemplary motion control software application (written in Python) according to an embodiment of the subject matter described herein.

It is appreciated that in the embodiment shown, an API (ERAS_Actions) may be implemented that is accessed via TCP for providing functions corresponding to system motions and logical updates. For example, the following Table includes various examples of functions that may be provided by the ERAS_Actions API.

| | |
|---|---|
| Load_Substrate | “Load_Substrate”#load canvas/glass/paper |
| | onto tilt table |
| Unload_Substrate | “Unload_Substrate” |
| Swap_Substrate | “Swap_Substrate” |
| Load_Syringe | “Load_Syringe” |
| Unload_Syringe | “Unload_Syringe” |
| Swap_Syringe | “Swap_Syringe” |
| Swap_Next_Syringe | “Swap_Next_Syringe” |
| Swap_Previous_Syringe | “Swap_Previous_Syringe” |
| Begin_Session | “Begin_Session” |
| End_Session | “End_Session” |
| Begin_Run | “Begin_Run” |
| End_Run | “End_Run” |
| Replay_Run | “Replay_Run” |
| Begin_Motif | “Begin_Motif” |
| End_Motif | “End_Motif” |
| Replay_Motif | “Replay_Motif” |
| Toggle_Dispense | “Toggle_Dispense” |
| Toggle_Withdraw | “Toggle_Withdraw” |
| Set_Rotate_Speed | “Set_Rotate_Speed” |
| Set_Dispense_Speed | “Set_Dispense_Speed” |
| Substrate_Neutral | Substrate_Neutral = “Substrate_Neutral” |
| Syringe_CNC_Mid | “Syringe_CNC_Mid” # redundant w/ |
| | Syringe_CNC_Pos? |
| Syringe_CNC_Jog | “Syringe_CNC_Jog” # jog to move the |
| | syringe |
| Substrate_CNC_Jog | “Substrate_CNC_Jog” # jog to rotate the |
| | substrate |
| Substrate_Tilt | “Substrate_Tilt” # move the substrate servos |
| Substrate_Target_Orientation | “Substrate_Target_Orientation” # set the |
| | substrate orientation |
| Substrate_Cont_Rotate | “Substrate_Cont_Rotate” # continuous |
| | substrate rotation |
| Substrate_CNC_Pos | “Substrate_CNC_Pos” # G1 command go to |
| | position |
| Syringe_CNC_Pos | “Syringe_CNC_Pos” # G1 command go to |
| | position |
| Jog_All | “Jog_All” # jog all devices at once |
| Home_Syringe | Home_Syringe = “Home_Syringe” |
| Power_On | “Power_On” # turn on power supplies |
| Power_Off | “Power_Off” # turn off power supplies |

Referring to FIG. 10, the functionality shown may be performed by one or more hardware classes and one or more data classes.

Data Classes include: Transport-Service 1001, JO-Orchestrator 1002, DB_-Session-Manager 1003, and Replayer 1004.

Transport-Service 1001 provides a TCP server/client protocol that relays messages to appropriate classes.

IO_Orchestrator 1002 decides what to do with every message received from Transport_Service. IO_Orchestrator 1002 routes messages to Replayer, Movement_Coordinator, or lower-level classes.

DB_Session_Manager 1003 tracks User, session, run, motif, gesture and interacts with the database to store and retrieve data. DB_Session_Manager 1003 also interacts with NFC tags on syringes to notify listeners which paint colors are loaded or available.

Replayer 1004 takes a given gesture, motif, or run, and replays it. Replayer 1004 also optionally allows the user to: use different syringes, replay up to a certain point (or start at a certain point), send live commands alongside the replayed commands and combine them on-the-fly to produce a modified output, blend multiple gestures and motifs together, and use post-processing methods on the gesture, motif, or run (i.e., generative art methods).

Hardware Classes include: Serial_Base, GRBL_Base, GRBL_Rotate_Dispense, GRBL_XYZ, and Movement_Coordinator functions.

Serial_Base may include a Connect function that handshakes with serial device to open a connection, a Sender function that includes an Async loop that checks write queue and does a serial.writeo if it finds a message in the queue, a Receiver function that is an Async loop that reads from the serial port periodically until a timeout or error occurs, and a Handle_Received functions that does class-specific stuff based on the received data.

GRBL_Base provides functionality for interacting with MCUs running GRBL. GRBL_Base may include a move_G1 function that receives a CNC_position and translates it into a G1 gcode command which then gets sent over a serial connection. GRBL_Base may also include a Write_queries function that periodically sends GRBL status query “?” to monitor the device. GRBL_Base may also include a Handle_received function that parses the message received from the status query into system position coordinates (x, y, z) and checks which state GRBL (Idle, Run, Jog, Alarm) is in and updates the class if changed.

GRBL_Rotate_Dispense controls the steppers driving the rotary table as well as syringe actuation. GRBL_Rotate_Dispense may also include a Toggle_rotation function that Toggles rotation in either the clockwise or counterclockwise direction. GRBL_Rotate_Dispense may also include a Toggle_dispense function that Toggles the dispense action to depress the syringe plunger or stop it. GRBL_Rotate_Dispense may also include a Set_rotate_vector function that Sets the rotation direction and speed within a given range. GRBL_Rotate_Dispense may also include a Set_dispense_speed function that Sets the dispense speed within a given range.

GRBL_XYZ function controls the x, y, and z axes of the system. This may include additional control functionality such as ensuring that commands are sent sequentially to improve response time, converting vectors into GRBL Jog commands, and limiting system movements to within a predefined boundary.

According to one embodiment, a Halfway_to_next_pos function is a method for filtering jog commands so that only one command is sent at a time while moving. Only allowing a jog command to be sent if the previous jog command is almost done improves the user experience by allowing for fast responses to input.

According to one embodiment, a Jog function is a method for converting a vector (x,y) into a GRBL Jog command. It is appreciated that Jog may be used instead of G1 because Jog can be cancelled and/or interrupted while G1 cannot be cancelled and/or interrupted.

According to one embodiment, a Limit_distance function may prevent the system from jogging outside a defined boundary. Typically, this boundary is based on (e.g., defined to be co-extensive with) the dimensions of substrate.

According to one embodiment, a Movement_Coordinator function coordinates all subsystems for higher level actions. Higher level actions may include swapping syringes. The Movement_Coordinator also handles messages and notifies listeners of what happened as a result of the message.

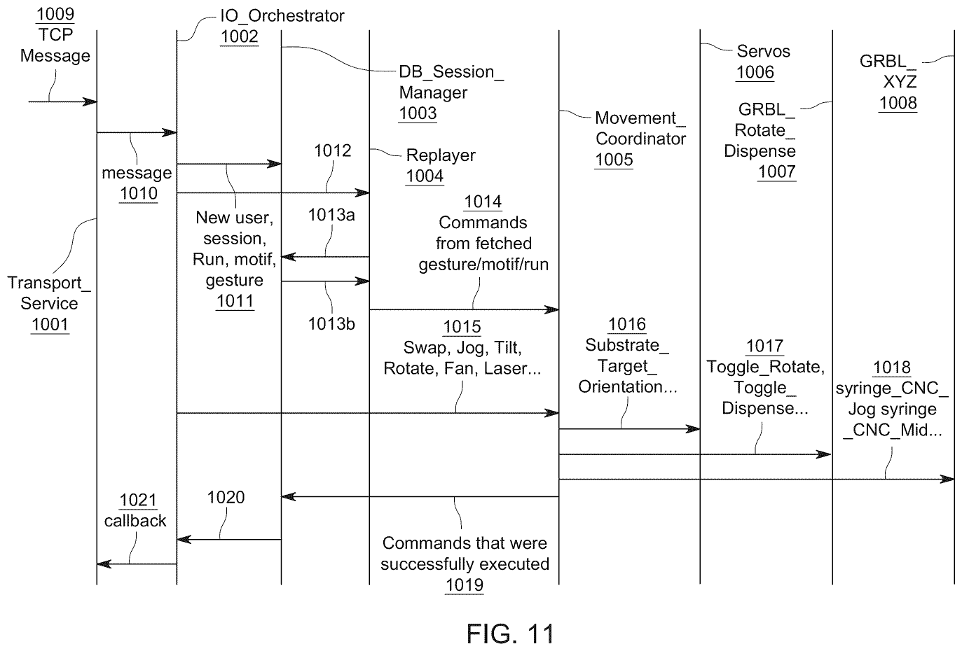

FIG. 11 is a message sequence diagram illustrating functions of an exemplary motion control software application (written in Python) according to an embodiment of the subject matter described herein. Here, the message sequence begins when tansport_service 1001 receives TCP message 1009. This may be produced from user input received from a remote UI. The transport_service 1001 forwards the message to IO_orchestrator 1002 which determines how to further route the message. IO_orchestrator 1002 may be configured, in some cases, to acknowledge receipt of the message 1010. Additionally, IO_orchestrator 1002 may send other, non-ack messages to transport_service 1001 independent of being responsive to receipt of message 1010.

IO_orchestrator 1002 may route the message to one of three other components—DB_Session_Manager 1003, Replayer 1004, or Movement_Coordinator 1005—depending on the content of the message. For example, a message requesting a new user may be routed to DB_Session_Manager 1003, while a message requesting replaying of a gesture or motif may be routed to Replayer 1004, and all other movement-related messages, such as jog, tilt, etc. message 1015, may be routed to the default Movement_Coordinator 1005.

Depending on the type of movement requested, Movement_Coordinator 1005 may route the message or provide instructions to additional components associated with each different, specific type of movement. For example, a substrate_target orientation message 1016 may be sent to servos 1006, while a toggle_rotate or toggle_dispense message 1017 may be sent to GRBL_Rotate_Dispense 1007, and a syringe_CNC_job message 1018 may be sent to GRBL_XYZ 1008.

Once a movement command has been successfully executed, acknowledgement or confirmation may be returned to Movement_Coordinator 1005, which may in turn be returned to DB_Session_Manager 1003 as messages 1019.

Upon receiving message 1012, Replayer 1004 may fetch details for one or more gestures or motifs indicated by the message 1012. This way, replayer 1004 does not maintain a separate copy of the gestures or motifs supported by the system. Instead, replayer 1004 may refer to a central repository of information. In response to the gesture/motif fetch request 1013a, DB_Session_Manger 1003 returns a gesture/motif fetch response 1013b to replayer 1004. This allows replayer 1004 to provide commands from the fetched gesture/motif 1014 to movement_coordinator 1005 for execution as described above.

In at least one other embodiment, the system described herein includes a fan for blowing the paint around. For example, the fan may be mounted on a robotic arm and the fan speed can be controlled using the digital user interface.

In at least one other embodiment, the system described herein includes a color sensor for each syringe to show the user the options in the UI (by updating the colors on screen).

In at least one other embodiment, the system described herein includes a RFID tag and/or RFID interrogator/reader for tracking which paint(s) is(are) in which syringe.

In at least one other embodiment, the system described herein includes using an ultraviolet (UV)-cured resin in at least one of the syringes. After dispensing the resin, the user can activate a UV lamp on as desired to cure it, thus enabling the creation of more textured artwork.

In at least one other embodiment, the system described herein includes an indicator LED to physically show the user when the system is dispensing (or should be dispensing). For example, a green LED may be located on the painting apparatus (e.g., gantry) and viewable by the camera and displayed to the user. When the green LED is lit, this may indicate that the user is actively dispensing paint from the selected syringe.

In at least one other embodiment, the system described herein includes laser positioning means. For example, one or more lasers may be aligned with the syringe to provide the user with an indication of where the paint will land on the surface prior to being dispensed.

In at least one other embodiment, the system described herein includes one or more oscillation modes for tilting and rotating the table and/or syringe. For example, the user may set a frequency and range of motion for each tilting or rotary axis so that it tilts and rotates back and forth periodically. This allows the user to precisely repeat certain patterns of rotation or tilting without requiring manual operation of the on-screen joysticks to do so.

In at least one other embodiment, the system described herein includes automated substrate loading and unloading means. For example, one or more robotic arms, actuators, or wheeled bots may move fresh substrates onto the tilt table, or unload coated substrates to a drying rack.

In at least one other embodiment, the system described herein includes a magnet that can be moved beneath the substrate so as to move a ferrous object, such as a ball, chain, or other such object, across the substrate, interacting with the paint. The magnet beneath the substrate is mounted on a gantry similar to the one for the X/Y axes with the syringe assembly.

In at least one other embodiment, the system described herein includes performing operations using vocal commands. For example, a microphone may be incorporated into the user interface that allows the user to say things like “Swap to syringe 1” or “Change the color to light blue”. These vocal commands may be automatically interpreted and executed by the system, which may be advantageous for users that cannot manually operate the on-screen controls of the digital user interface.

The word ‘exemplary’ is used herein to mean ‘serving as an example, instance, or illustration.’ Any embodiment described herein as ‘exemplary’ is not necessarily to be construed as preferred or advantageous over other embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving input from a user via a user interface;
automatically translating the user input into instructions that, when executed by a remotely located painting device, cause the operation of the painting device to be controlled by the user in real time or near real time; and
operating the movement and position of the painting device in real time or near real time based on the received instructions.

2. The method of claim 1, wherein the user input includes input indicating at least one of: a direction, a pitch, and a movement speed of the painting device.

3. The method of claim 1, wherein the user input includes an indication or selection of a color.

4. The method of claim 1, wherein the user input includes a timestamped sequence of vectors.

5. The method of claim 1, wherein the instructions include instructions for controlling at least one of: a position, a pitch, and a speed of the painting device.

6. The method of claim 1, further comprising displaying to the user in real time or near real time a video feed of at least one of the surface to be painted and the painting device.

7. The method of claim 1, wherein at least one of the user input and the instructions are stored.

8. The method of claim 7, wherein the stored user input or stored instructions are used to reproduce the operation of the painting device without additional user input.

9. The method of claim 1, further comprising creating a digital image of the artwork based on the physical instance of the artwork.

10. A system comprising:
a user interface for receiving input from a user;
a translation module for automatically translating the user input into instructions that, when executed by a remotely located painting device, cause the operation of the painting device to be controlled by the user in real time or near real time; and
a painting device for ejecting paint from one or more nozzles onto a physical surface for in real time or near real time based on the received instructions.

11. The system of claim 10, wherein the user input includes input indicating at least one of: a direction, a pitch, and a movement speed of the painting device.

12. The system of claim 10, wherein the user input includes an indication or selection of a color.

13. The system of claim 10, wherein the user input includes a timestamped sequence of vectors.

14. The system of claim 10, wherein the instructions include instructions for controlling at least one of: a position, a pitch, and a speed of the painting device.

15. The system of claim 10, further comprising displaying to the user in real time or near real time a video feed of at least one of the surface to be painted and the painting device.

16. The system of claim 10, wherein at least one of the user input and the instructions are stored.

17. The system of claim 16, wherein the stored user input or stored instructions are used to reproduce the operation of the painting device without additional user input.

18. The system of claim 10, further comprising creating a digital image of the artwork based on the physical instance of the artwork.

19. An apparatus comprising:
one or more painting devices, wherein the painting devices include at least one of a plurality of syringes, each syringe containing a paint and having a plunger;
a communications module receiving at least one of input from a user or instructions from a translation module, wherein the user input is automatically translated into the instructions such that, when executed by the painting device, they cause the operation of the painting device to be controlled by the user in real time or near real time; and
a control module for operating the movement and position of the painting device in real time or near real time based on the received instructions to eject paint from one or more nozzles onto a physical surface, wherein the control module is configured to communicate with one or more micro controller units for controlling the movement and position of the painting devices and to communicate with one or more stepper motors for controlling the plungers associated with each of the syringes for ejecting the paint therefrom.

20. A computer program product comprising:
a non-transitory computer readable storage medium having computer readable program code embodied therewith, the computer readable program code comprising computer readable program code configured to:
receive input from a user via a user interface;
automatically translate the user input into instructions that, when executed by a remotely located painting device, cause the operation of the painting device to be controlled by the user in real time or near real time; and
operate the movement and position of the painting device in real time or near real time based on the received instructions to eject paint from one or more nozzles onto a physical surface.
